(19) United States
(12) Patent Application Publication
(10) Pub. No.: US 2010/0193745 A1
(43) Pub. Date: Aug. 5, 2010

(54) CONDUCTIVE POLYMER FILM, CONDUCTIVE POLYMERIC MATERIAL AND ELECTRONIC DEVICE

(75) Inventors: Gaku HARADA, Kawanishi-city (JP); Takeshi SANO, Takatsuki-city (JP); Miwa OGAWA, Hirakata-city (JP); Makoto SHIRAKAWA, Hirakata-city (JP)

Correspondence Address: MOTS LAW, PLLC, 1629 K STREET N.W., SUITE 602, WASHINGTON, DC, 20006-1635, US

(73) Assignee: SANYO ELECTRIC CO., LTD., Moriguchi-city (JP)

(21) Appl. No.: 12/695,002

(22) Filed: Jan. 27, 2010

(30) Foreign Application Priority Data
Jan. 30, 2009 (JP) 2009-19424
Mar. 12, 2009 (JP) 2009-60121

(51) Int. Cl. H01B 1/12; C08G 79/04

(52) U.S. Cl. 252/500; 528/398

(57) ABSTRACT

A conductive polymer film obtained by using a polymerization liquid containing a monomer for a conductive polymer, an oxidizing agent, and an additive having a phosphonic acid group and an organic group or a polymerization liquid containing a monomer for a conductive polymer, an oxidizing agent, a basic first additive, and an acidic second additive to polymerize the monomer for the conductive polymer on a substrate, and an electronic device using the conductive polymer film.

### BACKGROUND OF THE INVENTION

1. Field of the Invention

This invention relates to conductive polymer films, conductive polymeric materials and electronic devices.

2. Description of Related Arts

Conductive polymers have polymer properties, such as flexibility and light weight, while also having electron conductivity like metal or semiconductivity. Taking advantage of this feature, conductive polymers are used in fields, such as antistats, cathode materials for solid electrolytic capacitors, electromagnetic shielding materials and transparent electrode materials. Furthermore, studies are being made on the application of conductive polymers to organic electroluminescence devices (organic EL devices), actuators, capacitors, transistors, solar cells, sensors, antirusts and so on. Particularly in some fields of application, such as cathode materials for solid electrolytic capacitors and transparent electrode materials for touch panels, there is demand for conductive polymers having electrical conductivity as high as possible. In order to increase the electrical conductivity, various kinds of dopants and additives for conductive polymers are being studied.

Meanwhile, in the application of conductive polymers to electronic devices, delamination of conductive polymer films or deterioration in the adherence thereof to substrates would increase the contact resistance and decrease the yield. Proposed methods for improving the adherence of a conductive polymer film to a substrate include methods using a silane coupling agent (see, for example, Published Japanese Patent Applications Nos. H02-074021, H04-073924 and H08-293436). The methods disclosed in Published Japanese Patent Applications Nos. H02-074021, H04-073924 and H08-293436 have the problem of a complicated film production process because the production process is implemented by two steps of: 1) treatment to the substrate using a coupling agent; and 2) film formation by polymerization reaction of a conductive polymer.

Published Japanese Patent Application No. 2006-140442 proposes a method in which polymerization is performed in a single step by adding a silane coupling agent to a polymerization liquid. The silane coupling agent used is one containing an alkoxysilane group having a coupling function and a sulfonate group functioning as a dopant. For such a silane coupling agent, in the vicinity of the substrate, some of its alkoxysilane groups react with the substrate and some of its sulfonate groups function as a dopant. On the other hand, in the conductive polymer film, some of the sulfonate groups function as a dopant, but some of the alkoxysilane groups are left as they are. Therefore, the residual silane coupling agent may cause a hydrolysis reaction, which may make the conductive polymer unstable and thereby provide insufficient adherence thereof to the substrate.

Conductive polymers are used, as described above, as cathode materials for solid electrolytic capacitors.

In relation to solid electrolytic capacitors, it is noted that their equivalent series resistance (ESR) can be reduced by increasing the electrical conductivity of conductive polymer films to be used as cathodes. As seen from this, improvement in the electrical conductivity of conductive polymer films in such electronic devices is a critical factor for the performance of the electronic devices. Therefore, research and development efforts are being directed toward increasing the electrical conductivity of conductive polymer films.

Under these circumstances, introduction of various additives has been recently studied as a method for increasing the electrical conductivity of such a conductive polymer film. Specifically, the use of additives, such as firstly “organic solvents”, secondly “basic compounds” and thirdly “acidic substances”, has been proposed as follows.

In relation to “organic solvents” as first described above, for example, it has been proposed to add an organic solvent, such as N-methylpyrrolidone or ethylene glycol, to a conductive polymer made of polythiophene and polyanion (see Japanese Patent No. 2916098). In relation to “basic compounds” as second described above, for example, it has been proposed to add a basic electrical conductivity improver to a conductive polymer paint containing a conductive polymer and polyanion (see Published Japanese Patent Application No. 2007-95506). Alternatively, it has been proposed to add a basic electrical conductivity improver to a monomer for producing a conductive polymer and oxidatively polymerize the monomer (see Published Japanese Patent Application No. 2008-171761 and Advanced Functional Materials 2004, 14, pp. 615). In relation to “acidic substances” as third described above, it has been proposed to add an acidic additive, for example, p-toluenesulfonate or aromatic dicarboxylate, to a monomer for producing a conductive polymer and oxidatively polymerize the monomer (see Published Japanese Patent Applications Nos. 2004-107552 and 2008-34440).

The electrical conductivity a of conductive polymer is expressed by the equation σ=enμ, where e represents the elementary electric charge, n represents the carrier density, and μ represents the mobility. As seen from this equation for the electrical conductivity σ, the value of electrical conductivity σ can be increased by increasing the carrier density n and the mobility μ. The inventors have found that in order to increase the carrier density n, it is important to increase the doping amount, and that in order to increase the mobility μ, it is important to increase the orientation of the conductive polymer.

In view of the above findings, the techniques disclosed in Published Japanese Patent No. 2916098 and Published Japanese Patent Application No. 2007-95506 have the following disadvantage. According to these techniques, the treatment using an additive is made after the formation of a conductive polymer. Therefore, it is impossible to improve the orientation of the conductive polymer. As for the techniques disclosed in Published Japanese Patent Applications Nos. 2004-107552 and 2008-34440, as the hydrogen ion exponent (hereinafter referred to as pH) of an oxidative polymerization liquid decreases, the reaction rate generally increases. Therefore, these techniques are disadvantageous in that if an additive having a low pH, i.e., an acidic additive, is added to a monomer for producing a conductive polymer, the orientation of a conductive polymer film obtained may be low. If like this the orientation of the conductive polymer is low, carriers in the conductive polymer cannot sufficiently move in and between molecular chains, which results in reduced electrical conductivity. According to the techniques disclosed in Published Japanese Patent Application No. 2008-171761 and Advanced Functional Materials 2004, 14, pp. 615, the addition of a basic additive can be expected to slow the polymerization rate and thereby provide a high-orientation conductive polymer film. On the other hand, the addition of a basic material reduces the reaction rate of polymerization reaction, which makes it difficult to provide a conductive polymer film having a sufficient thickness and results in reduced electrical conductivity of the conductive polymer film.

### SUMMARY OF THE INVENTION

A first object of the present invention is to provide a conductive polymer film having good adherence to the substrate and a device using the conductive polymer film.

A second object of the present invention is to increase the electrical conductivity of a conductive polymer film used for an electronic device and thereby increase the performance of the electronic device.

### First Aspect of the Invention

A conductive polymer film according to a first aspect of the invention is one obtained by using a polymerization liquid containing a monomer for a conductive polymer, an oxidizing agent, and an additive having a phosphonic acid group and an organic group to polymerize the monomer for the conductive polymer on a substrate.

According to the first aspect of the invention, by containing the additive in the conductive polymer film, the additive is adsorbed on the surface of the substrate on which the conductive polymer is to be formed. Thus, the surface of the substrate can be modified, which increases the adherence between the conductive polymer film and the substrate.

The additive in the first aspect of the invention may be an additive represented by the following general formula:

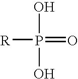

wherein R represents a hydrocarbon group having a carbon atom number of 1 to 20 or an alkyl group having a carbon atom number of 1 to 20.

The organic group R is preferably an organic group exhibiting hydrophobicity. From this point of view, preferable examples of the organic group R include hydrocarbon groups having a carbon atom number of 1 to 20 and alkyl groups having a carbon atom number of 1 to 20, and more preferable examples thereof include hydrocarbon groups having a carbon atom number of 6 to 18 and alkyl groups having a carbon atom number of 6 to 18. It can be considered that as the carbon number of the organic group R contained in the additive increases, the orientation of the conductive polymer can be further increased. However, if the carbon number of the organic group is too large, this makes it difficult to dissolve the additive in the polymerization liquid. Therefore, the carbon number is preferably not more than 20.

In the first aspect of the invention, the polymerization liquid preferably contains a nitrogen-containing aromatic heterocyclic compound as an electrical conductivity improver. It can be considered that such an electrical conductivity improver can slow the polymerization rate to increase the molecular orientation, thereby further increasing the electrical conductivity of the conductive polymer film.

A device according to the first aspect of the invention is a device using the conductive polymer film according to the first aspect of the invention. Examples of the device include solid electrolytic capacitors, organic EL devices, organic solar cells, organic transistors, touch panels and cell electrodes. By using the conductive polymer film according to the first aspect of the invention as a conductive film in such a device, the device can be a device which includes a conductive polymer film having good adherence to the substrate and excellent electrical conductivity.

A solid electrolytic capacitor, which is a device according to the first aspect of the invention, includes: an anode; a dielectric layer formed on the surface of the anode; a conductive polymer layer formed on the dielectric layer; and a cathode layer formed on the conductive polymer layer, wherein the conductive polymer film according to the first aspect of the invention is used in at least part of the conductive polymer layer.

In the solid electrolytic capacitor according to the first aspect of the invention, since the conductive polymer film according to the first aspect of the invention is used in at least part of the conductive polymer layer formed on the dielectric layer, the solid electrolytic capacitor can be a solid electrolytic capacitor including a conductive polymer having good adherence to the dielectric layer serving as a substrate and excellent electrical conductivity. Therefore, the capacitance of the solid electrolytic capacitor can be increased and the equivalent series resistance (ESR) thereof can be reduced.

According to the first aspect of the invention, a conductive polymer film can be provided which has good adherence to the substrate and excellent electrical conductivity.

Since the device according to the first aspect of the invention uses the conductive polymer film according to the first aspect of the invention, the device includes a conductive polymer film having good adherence to the substrate and excellent electrical conductivity.

Since in the solid electrolytic capacitor serving as a device according to the first aspect of the invention the conductive polymer film according to the first aspect of the invention is used in at least part of the conductive polymer layer formed on the dielectric layer, this increases the capacitance of the solid electrolytic capacitor and reduces the ESR thereof.

### Second Aspect of the Invention

A conductive polymer film according to the second aspect of the invention is one obtained by using a polymerization liquid containing a monomer for a conductive polymer, an oxidizing agent, a basic first additive, and an acidic second additive to polymerize the monomer.

According to the second aspect of the invention, by containing the two additives in the polymerization liquid, the reaction rate of the conductive polymer can be slowed to improve the doping rate and orientation of the conductive polymer. This increases the electrical conductivity of the conductive polymer film. Furthermore, it can be considered that the concurrent use of the basic additive and the acidic additive functions to stabilize the pH of the polymerization liquid. Thus, the reaction rate of the conductive polymer can be held slow and constant. Therefore, the doping rate and orientation of the entire conductive polymer film can be improved, thereby increasing the electrical conductivity of the conductive polymer film.

The first additive used in the second aspect of the invention may be at least one compound selected from the group consisting of nitrogen-containing aromatic heterocyclic compounds, compounds having an amido group and compounds having an imido group. The second additive used in the second aspect of the invention may be a compound having a phosphonic acid group.

A conductive polymeric material according to the second aspect of the invention is a conductive polymeric material in which phosphonic acid is attached to each end of the main chain of a polymer obtained by polymerizing a conducting monomer.

An electronic device according to the second aspect of the invention includes a conductive layer using the conductive polymer film according to the second aspect of the invention. Another electronic device according to the second aspect of the invention includes a conductive layer made of the conductive polymeric material according to the second aspect of the invention.

Examples of the above electronic devices according to the second aspect of the invention include solid electrolytic capacitors, organic EL devices, organic solar cells, organic transistors, touch panels and cell electrodes. By using the conductive polymer film according to the second aspect of the invention as a conductive film in such an electronic device, the device can be an electronic device which includes a conductive polymer film having excellent electrical conductivity.

A solid electrolytic capacitor, which is an electronic device according to the second aspect of the invention, is, for example, a solid electrolytic capacitor including: an anode; a dielectric layer formed on the surface of the anode; a conductive polymer layer formed on the dielectric layer; and a cathode layer formed on the conductive polymer layer, wherein the conductive polymer film according to the second aspect of the invention as described above or the conductive polymeric material according to the second aspect of the invention as described previously is used in at least part of the conductive polymer layer. Since in such a solid electrolytic capacitor the conductive polymer film or conductive polymeric material according to the second aspect of the invention both having excellent electrical conductivity can be used, this reduces the equivalent series resistance (ESR) of the solid electrolytic capacitor.

In order to obtain the conductive polymer film according to the second aspect of the invention, a production method can be employed for producing a high-electrical conductivity conductive polymer film by using a polymerization liquid containing a monomer for a conductive polymer, an oxidizing agent, a basic first additive and an acidic second additive to polymerize the monomer.

In order to obtain the electronic device according to the second aspect of the invention, a conductive polymer film to be included in the electronic device can be produced using the above-described production method. For example, in order to obtain the solid electrolytic capacitor that is an electronic device according to the second aspect of the invention, a high-electrical conductivity conductive polymer film can be formed by applying the above-described polymerization liquid onto the dielectric layer regarded as a substrate and polymerizing the above-described monomer for the conductive polymer.

Note that the number of types of monomer for a conductive polymer used in the present invention is not limited to one and may be two or more. In such a case, a conductive polymer film made of a copolymer can be provided.

According to the present invention, a conductive polymer film or conductive polymeric material excellent in electrical conductivity can be provided. Furthermore, an electronic device including a conductive polymer film excellent in electrical conductivity can be provided. Since in the solid electrolytic capacitor serving as a device according to the second aspect of the invention the conductive polymer film according to the second aspect of the invention is used in at least part of the conductive polymer layer formed on the dielectric layer, this reduces the ESR of the solid electrolytic capacitor.

### BRIEF DESCRIPTION OF THE DRAWINGS

FIG. 1 is a schematic cross-sectional view showing a solid electrolytic capacitor that is an embodiment of a device according to the present invention.

FIG. 2 is a schematic cross-sectional view showing an organic solar cell that is another embodiment of the device according to the present invention.

FIG. 3 shows a schematic perspective view showing a state in which a conductive polymer is oriented with respect to the substrate.

### DETAILED DESCRIPTION OF PREFERRED EMBODIMENTS

### First Aspect of the Invention

The first aspect of the invention will be described in more detail below.

### <Additive Having Phosphonic Acid Group and Organic Group>

An example of an additive having a phosphonic acid group and an organic group in the first aspect of the invention is an additive represented by the general formula described previously. By containing the additive in the conductive polymer film, the additive is adsorbed on the surface of the substrate on which the conductive polymer is to be formed. Thus, the surface of the substrate can be modified, which increases the adherence between the conductive polymer film and the substrate.

In addition, the additive in the first aspect of the invention can function also as a dopant for the conductive polymer. This increases the electrical conductivity of the conductive polymer film. Therefore, the additive in the first aspect of the invention acts as a coupling agent for the substrate and functions as a dopant for the conductive polymer. It can be seen that the reason for increase in electrical conductivity is that the additive having a phosphonic acid group and an organic group is taken in as a dopant for the conductive polymer and the organic group improves the orientation and crystallinity of the conductive polymer film. In addition, the phosphonic acid group in the additive acts as a coupling agent for adhesion between the substrate surface and the conductive polymer film and functions and reacts as a dopant. This reduces the likelihood that the additive will be left unreacted in the conductive polymer film. Therefore, the stability of the conductive polymer film can be increased, and in turn the adherence thereof to the substrate can be increased.

Silane coupling agents used in the related arts have the following problems. Part of such a silane coupling agent having not reacted with the substrate is left in the conductive polymer film. The mixture of the silane coupling agent having no electrical conductivity into the conductive polymer film decreases the electrical conductivity of the conductive polymer film. In addition, the residual silane coupling agent causes a hydrolysis reaction, which decreases the stability of the conductive polymer film and thereby provides insufficient adherence thereof to the substrate. In contrast, according to the first aspect of the invention, the likelihood that the additive will be left unreacted in the conductive polymer film can be reduced as described above. Therefore, the stability of the conductive polymer film can be increased, thereby increasing the adherence thereof to the substrate.

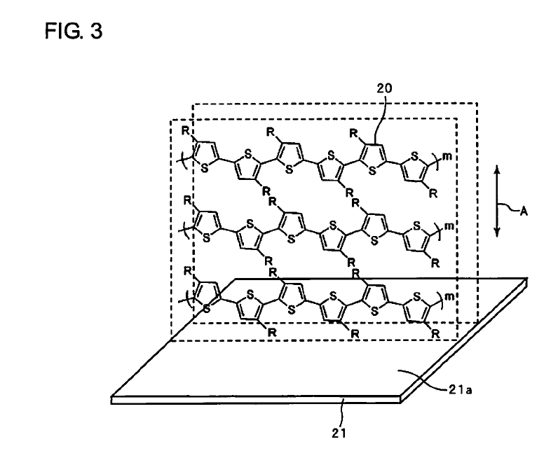

FIG. 3 is a schematic perspective view showing a state in which polythiophene serving as a conductive polymer is oriented with respect to the substrate. It is known that, as shown in FIG. 3, alkyl groups of polythiophene 20 serving as a conductive polymer are oriented to rise in a direction A perpendicular to the surface 21a of the substrate 21 and polymer chains thereof are oriented to lie over one another substantially in parallel to the surface of the substrate 21. The additive in the first aspect of the invention can be considered to be positioned so that its phosphonic acid groups are located at the positions of S (sulfur atoms) in the polythiophene oriented in the above manner and function as a dopant. In this case, the organic groups in the additive can be considered to be positioned to extend in the direction A perpendicular to the surface 21a of the substrate 21 and thereby further increase the orientation of the conductive polymer. Therefore, it can be considered that the additive in the first aspect of the invention can function as a dopant for the conductive polymer, which improves the orientation and crystallinity of the conductive polymer film and in turn increases the electrical conductivity.

Furthermore, since the phosphonic acid groups in the additive in the first aspect of the invention are doped in place of S in polythiophene as described above, the organic groups in the additive are oriented substantially perpendicularly to the substrate surface. This makes it easy to position the organic groups on the surface side of the conductive polymer film. Therefore, if an additive having an organic group exhibiting hydrophobicity is used, this increases the hydrophobicity of the surface of the conductive polymer film and gives water repellency to the conductive polymer film.

In the first aspect of the invention, the content of the additive in the conductive polymer film is preferably within the range of 0.1 mmol to 1 mol or the saturation concentration per mol of the monomer for the conductive polymer. If the additive content is too small, this may not sufficiently provide the effects of the first aspect of the invention: good adherence of the conductive polymer to the substrate and excellent electrical conductivity thereof. On the other hand, if the additive content is too large, the electrical conductivity of the conductive polymer may be decreased. The additive content is more preferably within the range of 0.5 mmol to 100 mmol, and still more preferably within the range of 0.5 mmol to 5 mmol.

### <Monomer for Conductive Polymer>

Examples of the monomer for the conductive polymer used in the first aspect of the invention include pyrrole, thiophene, aniline and their derivatives. By polymerizing the monomer, a π-conjugated conductive polymer having repeating units of the monomer can be obtained. Therefore, using the monomer, a conductive polymer made of, for example, a single polymer selected from the group consisting of polypyrroles, polythiophenes and polyanilines or their copolymer can be obtained.

The π-conjugated conductive polymer provides sufficient electrical conductivity even without substitution with any functional group. However, in order to further increase the electrical conductivity, a functional group, such as an alkyl group, a carboxylate group, a sulfonate group, an alkoxyl group, a hydroxyl group or a cyano group, is preferably introduced into the π-conjugated conductive polymer.

Specific examples of the π-conjugated conductive polymer include polypyrrole, poly(N-methylpyrrole), poly(3-methylpyrrole), poly(3-octylpyrrole), poly(3-decylpyrrole), poly(3-dodecylpyrrole), poly(3,4-dimethylpyrrole), poly(3,4-dibutylpyrrole), poly(3-carboxypyrrole), poly(3-methyl-4-carboxypyrrole), poly(3-methyl-4-carboxyethylpyrrole), poly(3-methyl-4-carboxybutylpyrrole), poly(3-hydroxypyrrole), poly(3-methoxypyrrole), poly(3,4-ethylenedioxypyrrole), polythiophene, poly(3-methylthiophene), poly(3-hexylthiophene), poly(3-heptylthiophene), poly(3-octylthiophene), poly(3-decylthiophene), poly(3-dodecylthiophene), poly(3-octadecylthiophene), poly(3-bromothiophene), poly(3,4-dimethylthiophene), poly(3,4-dibutylthiophene), poly(3-hydroxythiophene), poly(3-methoxythiophene), poly(3-ethoxythiophene), poly(3-butoxythiophene), poly(3-hexyloxythiophene), poly(3-heptyloxythiophene), poly(3-octyloxythiophene), poly(3-decyloxythiophene), poly(3-dedecyloxythiophene), poly(3-octadecyloxythiophene), poly(3,4-dihydroxythiophene), poly(3,4-dimethoxythiophene), poly(3,4-ethylenedioxythiophene), poly(3,4-propylenedioxythiophene), poly(3,4-butenedioxythiophene), poly(3-carboxythiophene), poly(3-methyl-4-carboxythiophene), poly(3-methyl-4-carboxyethylthiophene), poly(3-methyl-4-carboxybutylthiophene), polyaniline, poly(2-methylaniline), poly(3-isobutylaniline), poly(2-aniline sulfonic acid), poly(3-aniline sulfonic acid). Among them, polymers or copolymers made of one or two polymers selected from the group consisting of polypyrrole, polythiophene, poly(N-methylpyrrole), poly(3-methylthiophene), poly(3-methoxythiophene) and poly(3,4-ethylenedioxythiophene) are suitably used in terms of electrical conductivity. Furthermore, polypyrrole and poly(3,4-ethylenedioxythiophene) are more preferable because they provide high electrical conductivity and increased heat resistance.

### <Oxidizing Agent>

The oxidizing agent in the first aspect of the invention is used as a polymerization initiator for the monomer for producing the conductive polymer according to the first aspect of the invention. Examples of the oxidizing agent include peroxodisulfates, such as ammonium peroxodisulfate (ammonium persulfate), sodium peroxodisulfate (sodium persulfate) and potassium peroxodisulfate (potassium persulfate), transition metal compounds, such as ferric chloride, ferric sulfate, ferric nitrate and cupric chloride, metal halides, such as boron trifluoride, metal oxides, such as silver oxide and cesium oxide, peroxides, such as hydrogen peroxide and ozone, organic peroxides, such as benzoyl peroxide, and transition metal salts of organic sulfonic acid, such as iron (III) p-toluenesulfonate.

### <Electrical Conductivity Improver>

In the first aspect of the invention, an electrical conductivity improver may be contained in the conductive polymer film as described previously. By containing such an electrical conductivity improver, the electrical conductivity of the conductive polymer film can be further increased. Examples of the electrical conductivity improver used in this aspect of the invention include nitrogen-containing aromatic heterocyclic compounds. A single kind of electrical conductivity improver may be used or a plurality of kinds of electrical conductivity improvers may be used in combination.

Examples of the nitrogen-containing aromatic heterocyclic compounds include pyridines having one nitrogen atom and their derivatives, imidazoles having two nitrogen atoms and their derivatives, pyrimidines having two nitrogen atoms and their derivatives, pyrazines having two nitrogen atoms and their derivatives, and triazines having three nitrogen atoms and their derivatives. In terms of solvent solubility, preferable nitrogen-containing aromatic heterocyclic compounds are pyridines and their derivatives, imidazoles and their derivatives, and pyrimidines and their derivatives.

Specific examples of the pyridines and their derivatives include pyridine, 2-methylpyridine, 3-methylpyridine, 4-methylpyridine, 4-ethylpyridine, 2,4-dimethylpyridine, 2-vinylpyridine, 4-vinylpyridine, 2-methyl-6-vinylpyridine, 5-methyl-2-vinylpyridine, 4-butenylpyridine, 4-pentenylpyridine, 2,4,6-trimethylpyridine, 3-cyano-5-methylpyridine, 2-pyridinecarboxylic acid, 6-methyl-2-pyridinecarboxylic acid, 2,6-pyridine-dicarboxylic acid, 4-pyridinecarboxyaldehyde, 4-aminopyridine, 2,3-diaminopyridine, 2,6-diaminopyridine, 2,6-diamino-4-methylpyridine, 4-hydroxypyridine, 2,6-dihydroxypyridine, 6-hydroxynicotinic acid methyl, 2-hydroxy-5-pyridinemethanol, 6-hydroxynicotinic acid ethyl, 4-pyridinemethanol, 4-pyridineethanol, 2-phenylpyridine, 3-methylquinoline, 3-ethylquinoline, quinolinol, 2,3-cyclopentenopyridine, 2,3-cyclohexanopyridine, 1,2-di(4-pyridyl)ethane, 1,2-di(4-pyridyl)propane, 2-pyridinecarboxyaldehyde, 2-pyridinecarboxylic acid, 2-pyridinecarbonitrile, 2,3-pyridinedicarboxylic acid, 2,4-pyridinedicarboxylic acid, 2,5-pyridinedicarboxylic acid, 2,6-pyridinedicarboxylic acid, and 3-pyridinesulfonic acid.

Specific examples of the imidazoles and their derivatives include imidazole, 2-methylimidazole, 2-propylimidazole, 2-undecylimidazole, 2-phenylimidazole, N-methylimidazole, N-vinylimidazole, N-allylimidazole, 2-methyl-4-vinylimidazole, 2-methyl-1-vinylimidazole, 1-(2-hydroxyethyl)imidazole, 2-ethyl-4-methylimidazole, 1,2-dimethylimidazole, 1-benzyl-2-methylimidazole, 1-benzyl-2-phenylimidazole, 1-cyanoethyl-2-methylimidazole, 1-cyanoethyl-2-ethyl-4-methylimidazole, 2-phenyl-4,5-dihydroxymethylimidazole, 1-acetylimidazole, 4,5-imidazoledicarboxylic acid, 4,5-imidazoledicarboxylic acid dimethyl, benzimidazole, 2-aminobenzimidazole, 2-aminobenzimidazole-2-sulfonic acid, 2-amino-1-methylbenzimidazole, 2-hydroxybenzimidazole, and 2-(2-pyridyl)benzimidazole.

Specific examples of the pyrimidines and their derivatives include 2-amino-4-chloro-6-methylpyrimidine, 2-amino-6-chloro-4-methoxypyrimidine, 2-amino-4,6-dichloropyrimidine, 2-amino-4,6-dihydroxypyrimidine, 2-amino-4,6-dimethylpyrimidine, 2-amino-4,6-dimethoxypyrimidine, 2-aminopyrimidine, 2-amino-4-methylpyrimidine, 4,6-dihydroxypyrimidine, 2,4-dihydroxypyrimidine-5-carboxylic acid, 2,4,6-triaminopyrimidine, 2,4-dimethoxypyrimidine, 2,4,5-trihydroxypyrimidine, and 2,4-pyrimidinediol.

Specific examples of the pyrazines and their derivatives include pyrazine, 2-methylpyrazine, 2,5-dimethylpyrazine, pyrazine carboxylic acid, 2,3-pyrazine carboxylic acid, 5-methylpyrazine carboxylic acid, pyrazinamide, 5-methylpyrazinamide, 2-cyanopyrazine, aminopyrazine, 3-aminopyrazine-2-carboxylic acid, 2-ethyl-3-methylpyrazine, 2-ethyl-3-methylpyrazine, 2,3-dimethylpyrazine, and 2,3-diethylpyrazine.

Specific examples of the triazines and their derivatives include 1,3,5-triazine, 2-amino-1,3,5-triazine, 3-amino-1,2,4-triazine, 2,4-diamino-6-phenyl-1,3,5-triazine, 2,4,6-triamino-1,3,5-triazine, 2,4,6-tris(trifluoromethyl)-1,3,5-triazine, 2,4,6-tri-2-pyridine-1,3,5-triazine, 3-(2-pyridine)-5,6-bis(4-phenylsulfonic acid)-1,2,4-triazine disodium, 3-(2-pyridine)-5,6-diphenyl-1,2,4-triazine, and 2-hydroxy-4,6-dichloro-1,3,5-triazine.

The content of the electrical conductivity improver is preferably within the range of 0.1 to 10 mol per mol of oxidizing agent, more preferably within the range of 0.1 to 2 mol per mol of oxidizing agent, and still more preferably within the range of 0.5 to 1 mol per mol of oxidizing agent. If the content of the electrical conductivity improver is too small, this may not sufficiently provide the effect of the electrical conductivity improver, thereby tending to make the electrical conductivity low. On the other hand, if the content of the electrical conductivity improver is too large, this may make the polymerization reaction very slow, thereby tending to make it difficult to obtain a conductive polymer film.

### <Substrate>

In the first aspect of the invention, the type of the substrate on which the conductive polymer film is to be formed is not particularly limited. For example, the substrate may be any substrate that is used for a device having a conductive polymer film and serves as a matrix on which the conductive polymer film is to be formed. Examples of the substrate include substrates on the surface of which a metal oxide layer or a silicon oxide layer both containing oxygen atoms is formed. The oxygen atoms react with phosphonic acid in the additive, whereby the additive efficiently acts as a coupling agent for the substrate.

An example of the substrate on the surface of which a metal oxide layer is formed is a substrate which is made of a valve metal and the surface of which is oxidized by anodization to form a metal oxide layer. Alternatively, a substrate on the surface of which a conductive metal oxide layer is formed may be used as the substrate in this aspect of the invention. Thus, the substrate may be insulative or conductive.

Specific examples of materials of the metal oxide layer formed on the substrate surface include aluminum oxide, tantalum oxide, niobium oxide, titanium oxide, hafnium oxide, zirconium oxide, zinc oxide, tungsten oxide, bismuth oxide, antimony oxide, indium tin oxides (ITO), and indium zinc oxides (IZO).

Specific examples of materials of the silicon oxide layer include silicon oxide and glass.

An example of a method for forming a conductive polymer film on the substrate is a method of applying on the substrate a polymerization liquid containing a monomer for a conductive polymer, an oxidizing agent and an additive and polymerizing the monomer in the polymerization liquid. The method for applying the polymerization liquid on the substrate is not particularly limited. Examples of the application method include spin-coating, dipping, drop casting, ink-jet technique, spraying, screen printing, gravure printing, and flexography.

### <Solid Electrolytic Capacitor>

Examples of a device in which the conductive polymer film according to the first aspect of the invention is used include solid electrolytic capacitors.

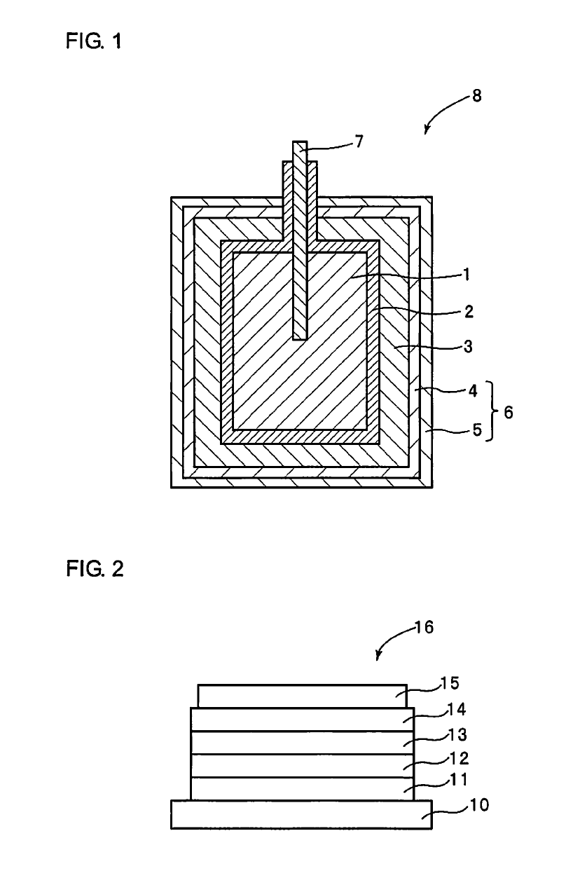

FIG. 1 is a schematic cross-sectional view showing a solid electrolytic capacitor that is an embodiment of a device according to the first aspect of the invention.

As shown in FIG. 1, an anode lead 7 is embedded in an anode 1. The anode 1 is made by forming powder of a valve metal or powder of an alloy containing a valve metal as a main ingredient into a formed body and then sintering the formed body. Thus, the anode 1 is formed of a porous body. Although not shown in FIG. 1, the porous body has a large number of fine pores formed to be open from inside to outside. The anode 1 thus made is formed to have the outer shape of an approximately rectangular box in this embodiment.

Examples of the valve metal include tantalum, niobium, titanium, aluminum, hafnium and zirconium. Valve metals particularly preferably used among them are tantalum, niobium, aluminum and titanium whose oxides serving as a dielectric are relatively stable even at high temperatures. Examples of the alloy containing a valve metal as a main ingredient include alloys made of two or more kinds of valve metals including tantalum, niobium and other valve metals.

A dielectric layer 2 made of an oxide is formed on the surface of the anode 1. The dielectric layer 2 is formed also on the surfaces of the pores in the anode 1. In FIG. 1, part of the dielectric layer 2 formed on the outer periphery of the anode 1 is schematically shown, while part of the dielectric layer on the surfaces of the pores in the porous body is not shown. The dielectric layer 2 can be formed by anodizing the surface of the anode 1.

A conductive polymer layer 3 is formed on the surface of the dielectric layer 2. At least part of the conductive polymer layer 3 can be made of the conductive polymer film according to the first aspect of the invention. The conductive polymer layer 3 is formed also on the part of the dielectric layer 2 lying on the surfaces of the pores in the anode 1.

A carbon layer 4 is formed on the part of the conductive polymer layer 3 lying over the outer periphery of the anode 1. A silver paste layer 5 is formed on the carbon layer 4. The carbon layer 4 and the silver paste layer 5 constitute a cathode layer 6. The carbon layer 4 can be formed by applying a carbon paste on the conductive polymer layer 3 and drying it. The silver paste layer 5 can be formed by applying a silver paste to the carbon layer 4 and drying it.

In the above manner, a solid electrolytic capacitor 8 of this embodiment is formed. Generally, a solid electrolytic capacitor 8 is provided so that it is covered with an exterior molded resin, an anode terminal is connected to the anode lead 7, a cathode terminal is connected to the cathode layer 6 and the terminals are led out to the outside of the exterior molded resin.

In this embodiment, since the conductive polymer film according to the first aspect of the invention is used in at least part of the conductive polymer layer 3, the conductive polymer layer 3 formed provides good adherence to the substrate serving as a matrix and excellent electrical conductivity. Since the conductive polymer film according to this aspect of the invention has good adherence to the substrate, in forming the conductive polymer layer 3 of a plurality of layers, the conductive polymer film according to this aspect of the invention is preferably used for a conductive polymer layer to be formed directly on the dielectric layer 2 containing oxygen atoms.

Since in the solid electrolytic capacitor of this embodiment the conductive polymer film according to the first aspect of the invention is used in at least part of the conductive polymer layer 3, this increases the capacitance of the solid electrolytic capacitor 8 and reduces the ESR thereof.

### <Organic Solar Cell>

FIG. 2 is a schematic cross-sectional view showing an organic solar cell that is another embodiment of the device according to the first aspect of the invention.

As shown in FIG. 2, a transparent electrode 11 is formed on a substrate 10. For example, a glass substrate can be used as the substrate 10. An example of the transparent electrode 11 is a thin film made of, for example, an indium tin oxide (ITO).

A hole transport layer 12 is formed on the transparent electrode 11. A conductive polymer film according to the first aspect of the invention can be formed as the hole transport layer 12. An active layer 13 is formed on the hole transport layer 12. A poly(3-hexylthiophene) film, for example, can be formed as the active layer 13. An electron transport layer 14 is formed on the active layer 13. A C60 fullerene film, for example, can be formed as the electron transport layer 14.

An upper electrode 15 is formed on the electron transport layer 14. A metal film made of, for example, aluminum, can be formed as the upper electrode 15.

In the above manner, an organic solar cell 16 of an embodiment according to the first aspect of the invention is formed.

In the organic solar cell of this embodiment, since the conductive polymer film according to the first aspect of the invention is formed as a hole transport layer 12, a hole transport layer 12 having good adherence and excellent electrical conductivity can be formed on the transparent electrode 11 formed on the substrate 10. Since, thus, the adherence between the transparent electrode 11 and the hole transport layer 12 can be increased and the electrical conductivity of the hole transport layer 12 can be increased, this reduces the IR drop due to interface resistance and bulk resistance and increases the open voltage.

### Second Aspect of the Invention

Next will be described in detail an embodiment of a conductive polymer film according to a second aspect of the invention.

A conductive polymer film according to the second aspect of the invention is obtained by polymerizing a monomer for a conductive polymer and is characterized in that a basic first additive and an acidic second additive are added together with an oxidizing agent to a polymerization liquid containing the monomer. By containing the basic first additive and the acidic second additive in the polymerization liquid as described above, the reaction rate of the conductive polymer can be slowed to improve the doping rate and orientation of the conductive polymer. This increases the electrical conductivity of the conductive polymer film. As described previously, it can be considered that when contained in the polymerization liquid, these additives function to stabilize the pH of the polymerization liquid. Therefore, the reaction rate of the conductive polymer can be held slow. Thus, the doping rate and orientation of the conductive polymer can be improved, thereby increasing the electrical conductivity of the conductive polymer film. Hence, the additives in the second aspect of the invention have not only the effect of slowing the reaction rate but also the effect of stabilizing the reaction rate. It can be seen that the reason for increase in electrical conductivity is that these additives improve the orientation, crystallinity and density of the conductive polymer film.

For example, in polymerizing a polymerizable monomer, such as 3,4-ethylenedioxythiophene, by chemical polymerization to obtain a conductive polymer (poly(3,4-ethylenedioxythiophene) (hereinafter referred to as PEDOT)), the lower the pH of the polymerization liquid, the higher the polymerization rate. As the polymerization rate increases in this manner, the quality and orientation of the PEDOT film decreases and in turn the electrical conductivity thereof decreases. Furthermore, if iron (III) p-toluenesulfonate is used as an oxidizing agent, the oxidizing agent is reduced into iron (II) p-toluenesulfonate and p-toluenesulfonate by reaction with the monomer. Part of the p-toluenesulfonate that is a reaction by-product is taken in as a dopant for the conductive polymer, but the rest thereof exists in the reaction solution. As the polymerization reaction progresses, the polymerization liquid increases the acidity and its pH decreases. Therefore, in this case, the polymerization rate increases with the progress of the polymerization reaction, so that a conductive polymer film having poor orientation is produced.

In the cases of additives used in the related arts to improve the electrical conductivity, a basic substance, such as pyridine or imidazole, is added to a polymerization liquid. Therefore, iron (III) p-toluenesulfonate serving as an acidic oxidizing agent reacts with pyridine or imidazole each serving as a basic additive, thereby reducing the oxidation action of the oxidizing agent itself. Furthermore, the addition of the basic substance increases the pH of the polymerization liquid. As a result of these actions, the reaction rate is slowed. Also in these case, like the above case, it can be expected that with the progress of the polymerization reaction, more p-toluenesulfonate is produced and the pH of the polymerization liquid is decreased, and with the progress of the polymerization reaction, the orientation of the conductive polymer film becomes more disturbed. This will make it difficult to obtain a high-electrical conductivity film.

For the additives in the second aspect of the invention, the first additive performs the effect of slowing the polymerization reaction, and both the first and second additives perform the buffer effect of keeping the pH of the polymerization liquid constant.

The above effect of slowing the reaction is provided in the following manner. Like the above cases, the basic substance, such as pyridine or imidazole, reacts with iron (III) p-toluenesulfonate serving as an acidic oxidizing agent to reduce the oxidation action of the oxidizing agent itself, and the addition of the basic substance increases the pH of the polymerization liquid. As a result, the rate of the polymerization reaction is slowed. Since the reaction rate is slowed in this manner, the orientation, crystallinity and density of the conductive polymer film can be improved.

On the other hand, the effect of keeping the pH constant can be considered to be an effect due to the buffer action. Specifically, when pyridine and a phosphonic acid compound are added as first and second additives, respectively, into a polymerization reaction solution made of 3,4-ethylenedioxythiophene (hereinafter referred to as EDOT) serving as a monomer for a conductive polymer and iron (III) p-toluenesulfonate serving as an oxidizing agent, part of basic pyridine reacts with acidic iron (III) p-toluenesulfonate to reduce the oxidization action of the oxidizing agent itself. Furthermore, the first and second additives cause acid-base reaction to produce a conjugate acid and a conjugate base. In addition, EDOT and the oxidizing agent cause polymerization reaction to produce poly(3,4-ethylenedioxythiophene) (PEDOT), iron (II) p-toluenesulfonate, p-toluenesulfonate anions and hydrogen cations (protons). The protons react with phosphonic acid anions by equilibrium reaction to provide phosphonic acid. Therefore, the pH variation of the polymerization liquid can be prevented. By preventing the pH variation, the reaction rate can be kept constant to maintain an optimal condition for polymerization reaction. Thus, the entire conductive polymer film can be kept at desired orientation, crystallinity and density, thereby increasing the electrical conductivity.

In the second aspect of the invention, the contents of the first and second additives in the polymerization liquid for the conductive polymer are preferably within the range of 0.01 mol to 1 mol and the range of 0.00001 mol to 0.1 mol, respectively, per mol of the oxidizing agent. If the contents of the additives are too small, this may not sufficiently provide the effect of the second aspect of the invention, i.e., the effect of providing excellent electrical conductivity. On the other hand, if the contents of the additives are too large, the electrical conductivity of the conductive polymer may be decreased. The content of the first additive is more preferably within the range of 0.05 to 0.5 mol, and still more preferably within the range of 0.3 to 0.5 mol. The content of the second additive is more preferably within the range of 0.0001 to 0.02 mol, and still more preferably within the range of 0.0001 to 0.002 mol.

The components of this embodiment of the conductive polymer film according to the second aspect of the invention will be sequentially described below.

### <Monomer for Conductive Polymer and Oxidizing Agent>

Examples of the monomer for the conductive polymer and oxidizing agent used in the second aspect of the invention include monomers for the conductive polymer and oxidizing agents, respectively, used in the first aspect of the invention.

### <First Additive>

The first additive in the second aspect of the invention is preferably a basic compound. In this respect, examples of the first additive include nitrogen-containing aromatic heterocyclic compounds, compounds having an amido group, compounds having an imido group, and compounds having an amino group. A single kind of first additive may be used or a plurality of kinds of first additives may be used in combination.

Examples of such a nitrogen-containing aromatic heterocyclic compound include pyridines having one nitrogen atom and their derivatives, imidazoles having two nitrogen atoms and their derivatives, pyrimidines having two nitrogen atoms and their derivatives, pyrazines having two nitrogen atoms and their derivatives, and triazines having three nitrogen atoms and their derivatives. In terms of solvent solubility, preferable nitrogen-containing aromatic heterocyclic compounds are pyridines and their derivatives, imidazoles and their derivatives, and pyrimidines and their derivatives.

Specific examples of the pyridines and their derivatives include pyridine, 2-methylpyridine, 3-methylpyridine, 4-methylpyridine, 4-ethylpyridine, 3-butylpyridine, 4-tert-butylpyridine, 2-butoxypyridine, 2,4-dimethylpyridine, 2-fluoropyridine, 2,6-difluoropyridine, 2,3,5,6-tetrafluoropyridine, 2-vinylpyridine, 4-vinylpyridine, 2-methyl-6-vinylpyridine, 5-methyl-2-vinylpyridine, 4-butenylpyridine, 4-pentenylpyridine, 2,4,6-trimethylpyridine, 3-cyano-5-methylpyridine, 2-pyridinecarboxylic acid, 6-methyl-2-pyridinecarboxylic acid, 2,6-pyridine-dicarboxylic acid, 4-pyridinecarboxyaldehyde, 4-aminopyridine, 2,3-diaminopyridine, 2,6-diaminopyridine, 2,6-diamino-4-methylpyridine, 4-hydroxypyridine, 2,6-dihydroxypyridine, 6-hydroxynicotinic acid methyl, 2-hydroxy-5-pyridinemethanol, 6-hydroxynicotinic acid ethyl, 4-pyridinemethanol, 4-pyridineethanol, 2-phenylpyridine, 3-methylquinoline, 3-ethylquinoline, quinolinol, 2,3-cyclopentenopyridine, 2,3-cyclohexanopyridine, 1,2-di(4-pyridyl)ethane, 1,2-di(4-pyridyl)propane, 2-pyridinecarboxyaldehyde, 2-pyridinecarboxylic acid, 2-pyridinecarbonitrile, 2,3-pyridinedicarboxylic acid, 2,4-pyridinedicarboxylic acid, 2,5-pyridinedicarboxylic acid, 2,6-pyridinedicarboxylic acid, and 3-pyridinesulfonic acid.

Specific examples of the imidazoles and their derivatives include imidazole, 2-methylimidazole, 2-ethylimidazole, 2-propylimidazole, 2-isopropylimidazole, 2-butylimidazole, 2-undecylimidazole, 2-heptadecylimidazole, 2-phenylimidazole, N-methylimidazole, N-vinylimidazole, N-allylimidazole, 2-methyl-4-vinylimidazole, 2-methyl-1-vinylimidazole, 1-(2-hydroxyethyl)imidazole, 2-ethyl-4-methylimidazole, 1,2-dimethylimidazole, 1-benzyl-2-methylimidazole, 1-benzyl-2-phenylimidazole, 1-cyanoethyl-2-methylimidazole, 1-cyanoethyl-2-ethyl-4-methylimidazole, 2-phenyl-4,5-dihydroxymethylimidazole, 1-acetylimidazole, 4,5-imidazoledicarboxylic acid, 4,5-imidazoledicarboxylic acid dimethyl, benzimidazole, 2-aminobenzimidazole, 2-aminobenzimidazole-2-sulfonic acid, 2-amino-1-methylbenzimidazole, 2-hydroxybenzimidazole, 2-(2-pyridyl)benzimidazole, 2-nonylimidazole, and carbonyldiimidazole.

Specific examples of the pyrimidines and their derivatives include 2-amino-4-chloro-6-methylpyrimidine, 2-amino-6-chloro-4-methoxypyrimidine, 2-amino-4,6-dichloropyrimidine, 2-amino-4,6-dihydroxypyrimidine, 2-amino-4,6-dimethylpyrimidine, 2-amino-4,6-dimethoxypyrimidine, 2-aminopyrimidine, 2-amino-4-methylpyrimidine, 4,6-dihydroxypyrimidine, 2,4-dihydroxypyrimidine-5-carboxylic acid, 2,4,6-triaminopyrimidine, 2,4-dimethoxypyrimidine, 2,4,5-trihydroxypyrimidine, and 2,4-pyrimidinediol.

Specific examples of the pyrazines and their derivatives include pyrazine, 2-methylpyrazine, 2,5-dimethylpyrazine, pyrazine carboxylic acid, 2,3-pyrazine carboxylic acid, 5-methylpyrazine carboxylic acid, pyrazinamide, 5-methylpyrazinamide, 2-cyanopyrazine, aminopyrazine, 3-aminopyrazine-2-carboxylic acid, 2-ethyl-3-methylpyrazine, 2-ethyl-3-methylpyrazine, 2,3-dimethylpyrazine, and 2,3-diethylpyrazine.

Specific examples of the triazines and their derivatives include 1,3,5-triazine, 2-amino-1,3,5-triazine, 3-amino-1,2,4-triazine, 2,4-diamino-6-phenyl-1,3,5-triazine, 2,4,6-triamino-1,3,5-triazine, 2,4,6-tris(trifluoromethyl)-1,3,5-triazine, 2,4,6-tri-2-pyridine-1,3,5-triazine, 3-(2-pyridine)-5,6-bis(4-phenylsulfonic acid)-1,2,4-triazine disodium, 3-(2-pyridine)-5,6-diphenyl-1,2,4-triazine, and 2-hydroxy-4,6-dichloro-1,3,5-triazine.

Specific examples of other nitrogen-containing aromatic heterocyclic compounds include indole, 1,2,3-benzotriazole, and 1H-benzotriazole-1-methanol.

### <Second Additive>

An example of the second additive is a phosphonic acid represented by the previously described general formula. More specifically, a compound having a phosphonic acid group represented by the following chemical formula (1) can be used:

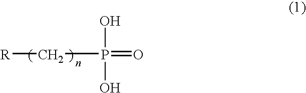

(n is an integer ranging from 0 to 20)
   wherein R represents a hydrocarbon group having a carbon atom number of 1 to 18, an alkyl group, an aryl group, a phenyl group, an ether group, a thiophene derivative, a pyrrole derivative, an aniline derivative, a derivative having a vinyl group, a derivative having an epoxy group (using an epoxycyclohexyl group, a glycidoxypropyl group or the like as a substituent), a derivative having a styryl group, a derivative having a methacryloxy group, a derivative having an acryloxy group, a derivative having an amino group (using an N-aminoethylaminopropyl group, an aminopropyl group, a dimethylbutylidene propylamine group, N-phenylaminopropyl group, N-vinylbenzylaminoethylaminopropyl group or the like as a substituent), a derivative having an ureido group (using an ureidopropyl group or the like as a substituent), a derivative having a chloropropyl group, a derivative having a mercapto group (using a methylmercaptopropyl group or the like as a substituent), a derivative having a sulfide group (using a tetrasulfide group or the like as a substituent), or a derivative having an isocyanato group (using an isocyanatopropyl group or the like as a substituent).

The contents of the first and second additives in the polymerization liquid for the conductive polymer are preferably within the range of 0.01 mol to 1 mol and the range of 0.00001 mol to 0.1 mol, respectively, per mol of the oxidizing agent. If the contents of the additives are too small, this may not sufficiently provide the effect of the second aspect of the invention, i.e., the effect of providing excellent electrical conductivity. On the other hand, if the contents of the additives are too large, the electrical conductivity of the conductive polymer may be decreased. The content of the first additive is more preferably within the range of 0.05 to 0.5 mol, and still more preferably within the range of 0.3 to 0.5 mol. The content of the second additive is more preferably within the range of 0.0001 to 0.02 mol, and still more preferably within the range of 0.0001 to 0.002 mol.

If the contents of the additives are too small, this may not sufficiently provide the effect of increasing the electrical conductivity, thereby tending to make the electrical conductivity low. On the other hand, if the contents of the additives are too large, this may increase the effect of slowing the polymerization, thereby tending to make the conductive polymer film thinner and make it difficult to obtain a sufficient film thickness.

### <Substrate and Conductive Polymer Film>

In the invention, a base material serving as a matrix on which a conductive polymer film is to be formed is referred to as a substrate. Therefore, for example, in an electronic device having a conductive polymer film, the underlying film thereof on which a conductive polymer film is to be formed corresponds to a substrate. More specifically, in such a solid electrolytic capacitor as described hereinafter, the dielectric layer corresponds to a substrate.

An example of a method for forming a conductive polymer film on the substrate is a method of applying on the substrate a polymerization liquid containing a monomer for a conductive polymer, an oxidizing agent and additives and polymerizing the monomer in the polymerization liquid. The method for applying the polymerization liquid on the substrate is not particularly limited. Examples of the application method include spin-coating, dipping, drop casting, ink-jet technique, spraying, screen printing, gravure printing, and flexography.

### <Conductive Polymeric Material>

A conductive polymeric material according to the second aspect of the invention is a polymeric material in which phosphonic acid is attached to each end of the main chain of a polymer obtained by polymerizing a plurality of units of a conducting monomer.

Examples of such a conductive polymeric material according to the second aspect of the invention include materials shown in the following formulae (2) to (5). Specifically, the conductive polymeric material of the formula (2) is a material in which phosphonic acid is attached to each end of the main chain of poly(3,4-ethylenedioxythiophene), and more specifically, 4-thienylbutylphosphonic acid (hereinafter referred to as TC4PHO) is attached to each end of the main chain of poly(3,4-ethylenedioxythiophene). Likewise, the conductive polymeric material of the formula (3) is a material in which TC4PHO is attached to each end of the main chain of polythiophene. The conductive polymeric material of the formula (4) is a material in which TC4PHO is attached to each end of the main chain of polypyrrole. The conductive polymeric material of the formula (5) is a material in which TC4PHO is attached to each end of the main chain of polyaniline.

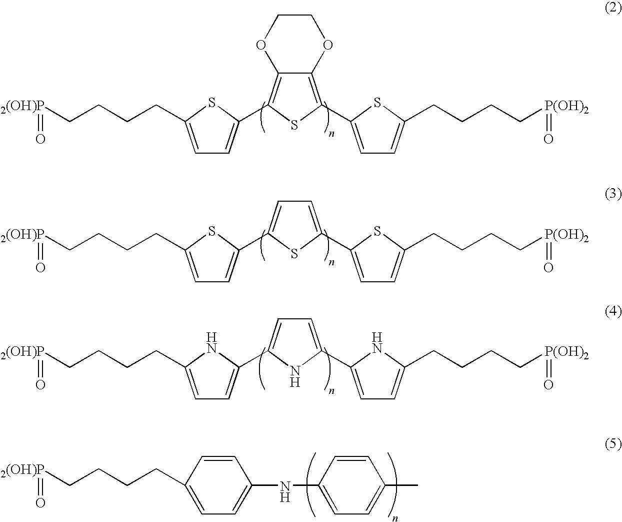

Next will be described a solid electrolytic capacitor that is an embodiment of an electronic device using the conductive polymer film according to the second aspect of the invention.

### <Solid Electrolytic Capacitor>

A solid electrolytic capacitor that is an embodiment of an electronic device according to the second aspect of the invention is, like the solid electrolytic capacitor that is an embodiment of the device according to the first aspect of the invention, shown in the schematic cross-sectional view of FIG. 1.

With reference to FIG. 1, a conductive polymer layer 3, which is a feature of the second aspect of the invention, is formed to cover a dielectric layer 2, and can be made of the above-described conductive polymer film according to the second aspect of the invention.

In such a solid electrolytic capacitor 8 of this embodiment, the conductive polymer layer 3 that is a feature of the second aspect of the invention is made of a conductive polymer film obtained by using a polymerization liquid containing such a monomer for a conductive polymer as described previously, such an oxidizing agent as described previously, and such first and second additives as described previously to polymerize the monomer. Usable materials for the conductive polymer include conductive polymeric materials shown as examples in the above formulae (2) to (5). The polymerization process will be described hereinafter.

Note that in FIG. 1 the conductive polymer layer 3 has a monolayer structure. However, if the conductive polymer layer 3 has a multilayer structure, at least part of the multilayer structure, i.e., at least one layer, may be made of the conductive polymer film according to the second aspect of the invention. For example, suppose there is used a conductive polymer layer 3 in which conductive polymer films having different electrical conductivities are laid one over another so that cathode-side one of the conductive polymer films has a higher electrical conductivity than anode-side one thereof. In this case, the conductive polymer film according to the second aspect of the invention can be used for the cathode-side conductive polymer film.

Such a conductive polymer layer 3 is also formed, but not shown in FIG. 1, on part of the dielectric layer 2 lying on the wall surfaces of the pores in the anode 1. Furthermore, the conductive polymer layer 3 is also formed over the outer periphery of the anode 1. A carbon layer 4 is formed on that part of the conductive polymer layer 3. A silver paste layer 5 is formed on the carbon layer 4.

In the solid electrolytic capacitor 8 of this embodiment, since the above-described conductive polymer film according to the second aspect of the invention is used in at least part of the conductive polymer layer 3, the conductive polymer layer 3 formed provides excellent electrical conductivity. Thus, since in the solid electrolytic capacitor of this embodiment the conductive polymer film according to the second aspect of the invention is used in at least part of the conductive polymer layer 3, this reduces the ESR of the solid electrolytic capacitor 8.

### <Organic Solar Cell>

An organic solar cell, which is another embodiment of the device according to the second aspect of the invention, is shown also in the schematic cross-sectional view of FIG. 2, like the embodiment according to the first aspect of the invention.

Therefore, a conductive polymer film according to the second aspect of the invention can be formed as a hole transport layer 12 shown in FIG. 2.

In the organic solar cell of this embodiment, since the conductive polymer film according to the second aspect of the invention is formed as a hole transport layer 12, a hole transport layer 12 having excellent electrical conductivity can be formed on the transparent electrode 11 formed on the substrate 10. Since, thus, the electrical conductivity of the hole transport layer 12 can be increased, this reduces the IR drop due to interface resistance and bulk resistance and increases the open voltage.

### EXAMPLES

### First Aspect of the Invention

Hereinafter, the first aspect of the invention will be described in more detail with reference to more concrete examples according to the first aspect of the invention. However, the first aspect of the invention is not limited to the following examples.

### Formation of Conductive Polymer Film on Glass Substrate

### Examples 1 to 4 and Comparative Example 1

A polymerization liquid for each of Examples 1 to 4 and Comparative Example 1 was prepared by mixing 3,4-ethylenedioxythiophene serving as a monomer for a conductive polymer, a 40% by weight butanol solution of iron (III) p-toluenesulfonate serving as an oxidizing agent and octadecylphosphonic acid (ODPA) serving as an additive in a given molar ratio shown in TABLE 1.

The polymerization liquid thus obtained was applied on a glass substrate by spin-coating, thereby forming a film on the glass substrate. After the film formation, the substrate was allowed to stand at 50° C. for an hour. Then, the film was washed in pure water to remove by-products, thereby forming a conductive polymer film on the glass substrate.

The cross-sectional area of the obtained conductive polymer film in the thickness direction and the length thereof were measured. The film thickness was measured with a stylus profilometer Dektak. The electrical conductivity of the conductive polymer film was measured with a resistivity meter Loresta MCP-T610 (made by Mitsubishi Chemical Analytech Co., Ltd.).

The contact angle of pure water on the surface of the conductive polymer film was also measured. The method for measuring the contact angle was implemented by dropwise adding water to a desired position of the conductive polymer film and measuring the angles of the conductive polymer film formed with water drops.

The content of phosphorous in the conductive polymer film was also measured by XPS. Specifically, the measurement was made by irradiating a specimen of the conductive polymer film with X-rays in a vacuum condition (at 10⁻⁹ Torr) and measuring a specific binding energy emitted from the specimen surface upon exposure to X-rays.

Furthermore, the adherence between the glass substrate and the conductive polymer film was evaluated. Specifically, if delamination was observed between the glass substrate and the conductive polymer film in the example, the example was evaluated as “delamination”. On the other hand, if no delamination was observed between them, the example was evaluated as “good”.

The evaluation results are shown in TABLE 1.

### Examples 5 to 8 and Comparative Example 2

A conductive polymer film of each of Examples 5 to 8 and Comparative Example 2 was formed on a glass substrate in the same manner as in Examples 1 to 4, except that imidazole serving as an electrical conductivity improver was further added to the polymerization liquid in a proportion shown in TABLE 1 and the polymerization liquid was used to form the conductive polymer film.

The conductive polymer film thus obtained was evaluated for electrical conductivity, contact angle, phosphorous content in the film and adherence to the substrate in the same manner as described above. The evaluation results are shown in TABLE 1.

### <Formation of Conductive Polymer Film on Ta₂O₅Substrate>

Conductive polymer films were formed on Ta₂O₅ substrates, instead of glass substrates, in the same manner as in Examples 1 to 8 and Comparative Examples 1 and 2. Each Ta₂O₅ substrate was produced by anodizing a Ta substrate with an applied voltage of 30 V in an aqueous solution of phosphate to form a Ta₂O₅ film on the surface of Ta.

On Ta₂O₅ substrates thus produced were formed conductive polymer films in the same manner as described above. The obtained conductive polymer films were evaluated for adherence to their respective substrates. The evaluation results are shown in TABLE 1.

TABLE 1

| | | | | | | | Phosphorous | | |
|---|---|---|---|---|---|---|---|---|---|
| | Film Formation | | | | | Contact | Content | Adherence | |
| | Condition (molar ratio) | | | | Conductivity | Angle | in Film | to Substrate | |
| | Monomer | Oxidant | ODPA | Imidazole | (S/cm) | (°) | (atm %) | Glass | Ta₂O₅ |
| Comp. Ex. 1 | 1 | 2 | 0.0000 | 0 | 276 | 60 | 0.0 | Delamination | Delamination |
| Ex. 1 | 1 | 2 | 0.0005 | 0 | 324 | 55 | 0.2 | Good | Good |
| Ex. 2 | 1 | 2 | 0.0010 | 0 | 311 | 61 | 0.1 | Good | Good |
| Ex. 3 | 1 | 2 | 0.0020 | 0 | 281 | 82 | 1.4 | Good | Good |
| Ex. 4 | 1 | 2 | 0.0050 | 0 | 260 | 92 | 1.3 | Good | Good |
| Comp. Ex. 2 | 1 | 2 | 0.0000 | 1 | 664 | 53 | 0.0 | Delamination | Delamination |
| Ex. 5 | 1 | 2 | 0.0005 | 1 | 752 | 65 | 0.3 | Good | Good |
| Ex. 6 | 1 | 2 | 0.0010 | 1 | 672 | 54 | 0.1 | Good | Good |
| Ex. 7 | 1 | 2 | 0.0020 | 1 | 620 | 65 | 0.3 | Good | Good |
| Ex. 8 | 1 | 2 | 0.0050 | 1 | 651 | 62 | 0.3 | Good | Good |

Referring to TABLE 1, in the conductive polymer films of Examples 1 to 8 formed by adding ODPA as an additive into the polymerization liquid according to the first aspect of the invention, good adherence to the substrates was achieved.

Furthermore, Examples 1 to 3, 5 and 6 obtained by adding ODPA according to the first aspect of the invention exhibited high electrical conductivities compared to Comparative Examples 1 and 2 obtained from polymerization liquids to which no ODPA was added. Example 4 exhibited the same degree of electrical conductivity as or slightly lower electrical conductivity than Comparative Example 1 obtained by a polymerization liquid to which no ODPA was added. Examples 7 to 8 exhibited the same degree of electrical conductivity as or slightly lower electrical conductivity than Comparative Example 2 obtained by a polymerization liquid to which no ODPA was added. However, the good adherence to substrate of these inventive examples can reduce the contact resistance between the substrate and the conductive polymer film, which provides excellent electrical conductivity in the device. For example, when these inventive examples are used in solid electrolytic capacitors, the good adherence between the conductive polymer film and the dielectric layer can reduce the contact resistance therebetween, which provides excellent electrical conductivity. Therefore, the capacitance of the solid electrolytic capacitor can be increased and the ESR thereof can be reduced.

Referring again to TABLE 1, in Examples 1 to 4 obtained from polymerization liquids to which no imidazole was added, the phosphorous content in film increased with increasing amount of ODPA added. Therefore, it can be considered that the phosphorous content in film was approximately proportional to the content of ODPA in the polymerization liquid. In addition, as the ODPA content increased, the contact angle also increased, whereby the surface of the conductive polymer film was given higher repellency. Thus, the incorporation of such an additive having a hydrophobic organic group, such as an alkyl group, into the polymerization liquid allows the repellency control. If the conductive polymer film is given repellency, it becomes less likely to adsorb moisture and more likely to adsorb hydrophobic substances. Therefore, as in the above inventive examples, the contact angle of the conductive polymer film can be controlled by adjusting the concentration of ODPA. This allows the repellency to be adjusted according to the nature of a layer to be formed on the conductive polymer film, thereby further extending the range of device design.

On the other hand, in Examples 5 to 8 obtained from polymerization liquids to which imidazole was added, the phosphorous content in film did not increase in proportion to the increase in ODPA content in the polymerization liquid. It can be understood that the reason for this is that basic imidazole reacted with phosphonic acid groups in the additive to prevent the doping amount of additive in the conductive polymer film from increasing. Furthermore, Examples 5 to 8 could not increase the contact angle with increasing ODPA content, unlike Examples 1 to 4. In Examples 5 to 8, imidazole was added as an electrical conductivity improver in order to further increase the electrical conductivity. It can be considered that for this reason, in Examples 5 to 8, basic imidazole reacted with phosphonic acid groups in the additive to make it difficult for the conductive polymer to be doped with phosphonic acid groups and thereby make it difficult for organic groups to be taken into the conductive polymer, thereby preventing the contact angle from being increased.

As seen from the above, according to the first aspect of the invention, a conductive polymer film can be formed which has good adherence to the substrate and excellent electrical conductivity.

### <Production of Solid Electrolytic Capacitor>

A solid electrolytic capacitor having a structure shown in FIG. 1 was produced. An anode 1 was made of a sintered body obtained by sinter forming tantalum (Ta) powder. The anode 1 has the shape of a rectangular box of 2.3 mm×1.8 mm×1.0 mm. The anode 1 of rectangular box shape has an anode lead 7 embedded in an end surface (2.3 mm×1.0 mm) thereof. The anode lead 7 is made of tantalum (Ta).

The anode 1 having the anode lead 7 embedded therein was immersed in a phosphoric acid aqueous solution kept at 65° C., and anodized for 10 hours by applying a constant voltage of 10 V to the anode 1, thereby forming a dielectric layer 2 on the surface of the anode 1. The dielectric layer 2 is formed also on the surfaces of the pores in the porous body of the anode 1, as described previously.

Next, the anode 1 having the dielectric layer 2 formed thereon was immersed into a polymerization liquid. The polymerization liquid used was a butanol solution prepared by mixing 3,4-ethylenedioxythiophene serving as a monomer for a conductive polymer, iron (III) p-toluenesulfonate serving as an oxidizing agent and octadecylphosphonic acid (ODPA) serving as an additive in a molar ratio of 1:2:0.0005.

The anode 1 having the dielectric layer 2 formed thereon was immersed into the above polymerization liquid, and then picked up and dried, thereby forming a conductive polymer film on the dielectric layer 2. The immersion into the polymerization liquid and drying were repeated, thereby forming a conductive polymer layer 3 with a thickness of 50 μm.

Next, a carbon layer 4 and a silver paste layer 5 were sequentially formed on the conductive polymer layer 3 lying over the outer periphery of the anode 1, thereby providing a cathode layer 6 constituted by the carbon layer 4 and the silver paste layer 5.

An anode terminal was welded to the anode lead 7 of a solid electrolytic capacitor 8 thus produced, and a cathode terminal was connected to the cathode layer 6 by a conductive adhesive. Then, the outside surface of the solid electrolytic capacitor 8 was covered with epoxy resin to seal it, thereby completing a final solid electrolytic capacitor product.

The solid electrolytic capacitor thus obtained was measured in terms of capacitance and ESR.

The measurement of capacitance was made using an LCR meter (inductance-capacitance-resistance meter) with a frequency 120 Hz.

The measurement of ESR was made using the same LCR meter with a frequency of 100 kHz.

The results of measurements made in the above manner were a capacitance of 530 μF and an ESR of 6.5 mΩ.

For comparison, a conductive polymer film was formed in the same manner as above except that no octadecylphosphonic acid serving as an additive was added to the polymerization liquid, and a solid electrolytic capacitor was produced using the conductive polymer film.

The solid electrolytic capacitor for comparison was also measured in terms of capacitance and ESR in the same manner as above. The measurement results were a capacitance of 510 μF and an ESR of 7.0 mΩ.

As seen from the above, by forming a conductive polymer layer in a solid electrolytic capacitor according to the first aspect of the invention, the adherence of the conductive polymer layer 3 to the dielectric layer 2 could be increased and the electrical conductivity of the conductive polymer layer 3 could be increased. Therefore, the capacitance could be increased and the ESR could be reduced.

### <Production of Organic Solar Cell>

An organic solar cell having a structure shown in FIG. 2 was produced. The surface of a transparent electrode 11 made of ITO was spin coated with a polymerization liquid made of a butanol solution obtained by mixing 3,4-ethylenedioxythiophene serving as a monomer for a conductive polymer, iron (III) p-toluenesulfonate serving as an oxidizing agent and octadecylphosphonic acid (ODPA) serving as an additive in a molar ratio of 1:2:0.0005. Thereafter, the spin-coated transparent electrode 11 was allowed to stand at 50° C. for an hour, then washed in pure water and then dried, thereby forming a hole transport layer 12. Therefore, the hole transport layer 12 was formed of a thin film of poly(3,4-ethylenedioxythiophene) having a thickness of 50 nm.

Next, the hole transport layer 12 was spin coated with an o-dichlorobenzene solution of poly(3-hexylthiophene), thereby forming an active layer 13 with a thickness of 50 nm.

A C60 fullerene film was vacuum deposited on the active layer 13 to form an electron transport layer 14 with a thickness of 50 nm.

Next, an Al film was vacuum deposited on the electron transport layer 14 using a shadow mask, thereby forming an upper electrode 15. Next, the semifinished product was sealed with a glass cap, thereby completing an organic solar cell 16. When the organic solar cell thus produced was irradiated with simulated solar light with AM1.5 (100 mW/cm²), an electromotive force of 550 mV was obtained as an open voltage.

For comparison, a hole transport layer 12 was formed in the same manner as above except that no octadecyl phosphonic acid serving as an additive was added to the polymerization liquid, and an organic solar cell was produced using the hole transport layer 12.

When the organic solar cell for comparison was irradiated with simulated solar light in the same manner, an electromotive force of 500 mV was obtained as an open voltage.

As seen from the above results, by forming the conductive polymer film according to the first aspect of the invention as a hole transport layer 12, the adherence of the hole transport layer 12 to the transparent electrode 11 could be improved. In addition, the electrical conductivity thereof could be increased, whereby the IR drop due to interface resistance and bulk resistance could be reduced and the open voltage could be increased.

### Second Aspect of the Invention

Hereinafter, the second aspect of the invention will be described in more detail with reference to more concrete examples according to the second aspect of the invention. However, the second aspect of the invention is not limited to the following examples.

### Conductive Polymer Film Formed on Glass Substrate

### Examples 9 to 13

A solvent obtained by adding 3-butylpyridine serving as a first additive to a 40% by weight butanol solution of iron (III) p-toluenesulfonate serving as an oxidizing agent in a given molar ratio shown in TABLE 2 was mixed with a solution obtained by adding a butanol solution of TC4PHO serving as a second additive to 3,4-ethylenedioxythiophene serving as a monomer for a conductive polymer in a given molar ratio shown in TABLE 2, thereby preparing a polymerization liquid. The polymerization liquid thus obtained was applied on a glass substrate by spin-coating, thereby forming a film on the glass substrate. After the film formation, the substrate was allowed to stand for an hour while applying heat at 50° C. Then, the film was washed in pure water to remove by-products, thereby forming a conductive polymer film on the glass substrate. The thickness of the conductive polymer film obtained was measured with a stylus profilometer Dektak. The electrical conductivity of the conductive polymer film was measured with a resistivity meter Loresta MCP-T610 (made by Mitsubishi Chemical Analytech Co., Ltd.). The evaluation results are shown in TABLE 2.

In the process of formation of a conductive polymer film according to the second aspect of the invention in the above examples, the polymerization reaction of the monomer in the polymerization liquid was initiated upon application of the polymerization liquid to the glass substrate, and terminated upon completion of heat application of the substrate at 50° C. for an hour. The reaction is as shown in the following reaction formula (6).

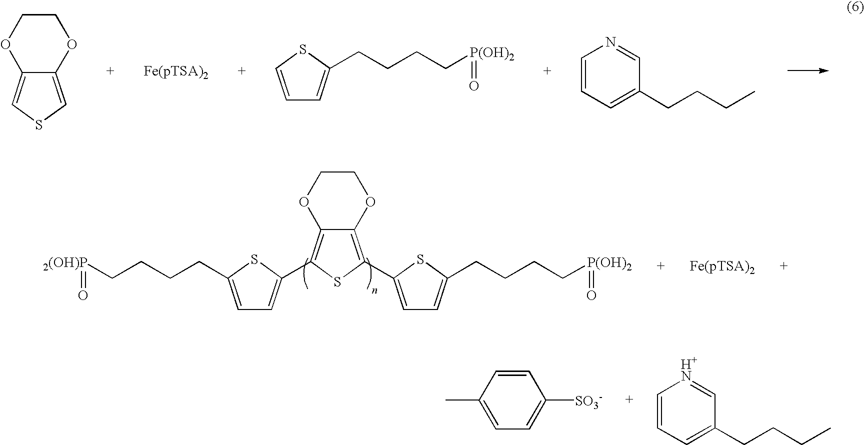

As seen from the above reaction formula (6), each of the conductive polymer films of Examples 9 to 13 is made of a conductive polymeric material according to the second aspect of the invention expressed by the previously described chemical formula (2).

### Comparative Example 3

In Comparative Example 3, a conductive polymer film was formed on a glass substrate in the same manner as in the above inventive examples, except that a polymerization liquid containing no additive was used to form the conductive polymer film. The conductive polymer film thus obtained was evaluated for electrical conductivity in the same manner as described above. The evaluation result is shown in TABLE 2.

### Comparative Example 4

In Comparative Example 4, a conductive polymer film was formed on a glass substrate in the same manner as in the above inventive examples, except that a polymerization liquid containing a first additive (3-butylpyridine) but no second additive was used to form the conductive polymer film. The conductive polymer film thus obtained was evaluated for electrical conductivity in the same manner as described above. The evaluation result is shown in TABLE 2.

### Comparative Examples 5 to 9

In Comparative Examples 5 to 9, each of conductive polymer films was formed on a glass substrate in the same manner as in the above inventive examples, except that a polymerization liquid containing a second additive (TC4PHO) but no first additive was used to form the conductive polymer film. The conductive polymer films thus obtained were evaluated for electrical conductivity in the same manner as described above. The evaluation results are shown in TABLE 2.

TABLE 2

| | Film Formation Condition | | | | |
|---|---|---|---|---|---|
| | | Oxidizing | First | Second | |
| | Monomer | Agent | Additive | Additive | Conductivity |
| | (mol) | (mol) | (mol) | (mmol) | (S/cm) |
| Comp. | 1 | 8 | 0 | 0 | 797 |
| Ex. 3 | | | | | |
| Ex. 9 | 1 | 8 | 4 | 1 | 1302 |
| Ex. 10 | 1 | 8 | 4 | 2 | 1287 |
| Ex. 11 | 1 | 8 | 4 | 5 | 1235 |
| Ex. 12 | 1 | 8 | 4 | 10 | 1211 |
| Ex. 13 | 1 | 8 | 4 | 100 | 1114 |
| Comp. | 1 | 8 | 4 | 0 | 1112 |
| Ex. 4 | | | | | |
| Comp. | 1 | 8 | 0 | 1 | 781 |
| Ex. 5 | | | | | |
| Comp. | 1 | 8 | 0 | 2 | 778 |
| Ex. 6 | | | | | |
| Comp. | 1 | 8 | 0 | 5 | 764 |
| Ex. 7 | | | | | |
| Comp. | 1 | 8 | 0 | 10 | 755 |
| Ex. 8 | | | | | |
| Comp. | 1 | 8 | 0 | 100 | 712 |
| Ex. 9 | | | | | |

### <Synthesis of TC4PHO>

A method for synthesizing TC4PHO serving as a second additive used in the above examples will be described below with reference to the chemical formula (7).

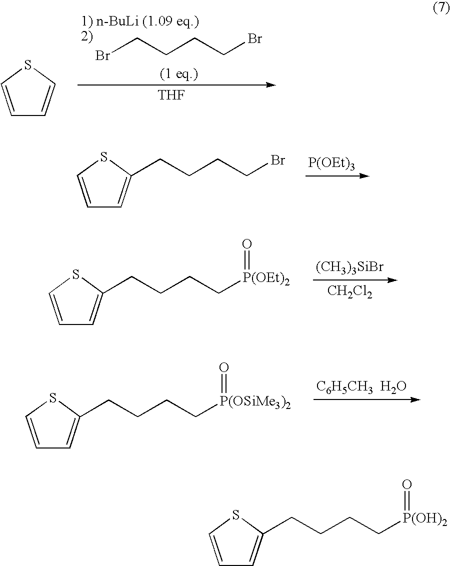

As shown in the chemical formula (7), 5.05 g (60 mmol) of thiophene (99%) was dissolved in 200 mL of dry tetrahydrofuran (THF). The solution was cooled to −70° C. Thereafter, 41 mL of 1.6 M n-butyllithium (N-BuLi) in hexane (65.6 mmol, 1.09 eq.) was added dropwise to the solution using a syringe while stirring with a magnet stirrer. Then, the temperature of the solution was gradually warmed to −50° C. Thereafter to the solution was added dropwise, using a syringe, a solution obtained by diluting 12.96 g of 1,4-dibromobutane with 50 mL of dry THF. The mixed solution was stirred at −50° C. for 30 minutes, and then gradually warmed to room temperature while being stirred, followed by allowing the solution to react for 10 hours. The reaction was terminated by adding 50 mL of pure water to the solution, and the reaction solution was moved to a separating funnel. To the reaction solution in the funnel was further added 100 mL of pure water to wash the reaction solution, and a reaction product was extracted into an oil layer. The layer containing the reaction product was concentrated with a rotary evaporator to give a crude product. Then, the crude product was purified on a silica gel column using hexane as an extraction liquid. The amount of product (2-(4-bromobutylthiophene)) yielded was 6.75 g (30 mmol, yield: 50%). Next, 5.0 g (30 mmol) of triethyl phosphite was added to the product while stirring them, followed by gradually warming from room temperature to 140° C. Then, the product underwent reaction at 140° C. for three hours. The product was cooled to room temperature, and the solvent was removed. Thereafter, the product was purified on a silica gel column, thereby obtaining 5.8 g of ethyl phosphite compound (21 mmol, the yield from 2-(4-bromobutylthiophene): 70). To the obtained compound were added bromotrimethylsilane and methylene chloride, followed by undergoing reaction at 5° C. for four hours. The solvent in the reaction solution was removed, followed by addition of toluene and water and then stirring overnight. The reaction solution was concentrated to obtain a concentrate. The concentrate was washed by adding toluene and then dried, thereby obtaining 4.1 g of TC4PHO (18.9 mmol, total yield: 31.5) as an objective substance.

The evaluation results of the examples of the second aspect of the invention will be explained below with reference to TABLE 2.

Referring to TABLE 2, the conductive polymer films of Examples 9 to 13, which were formed by adding 3-butylpyridine serving as a first additive and TC4PHO serving as a second additive to the polymerization liquid according to the second aspect of the invention, exhibited higher electrical conductivities than Comparative Example 3 formed by adding no additive to the polymerization liquid and Comparative Examples 4 to 7 formed by adding a single kind of additive to the polymerization liquid. Referring to the result of Comparative Example 4, the use of only a basic first additive as in the related arts provided an electrical conductivity of 1112 S/cm. On the other hand, Examples 9 to 13 obtained by addition of the first and second additives in the second aspect of the invention exhibited higher electrical conductivities (i.e., 1114 S/cm or more). Particularly, Examples 9 to 12 achieved electrical conductivities more than 1200 S/cm, and Example 9 achieved an electrical conductivity more than 1300 S/cm.

Considering differences in electrical conductivity between Comparative Examples 3 to 9, it can be seen that when only TC4PHO serving as a second additive was added without the first additive, as the amount of second additive was increased, the electrical conductivity decreased. However, it can be found that, as shown in the results of Examples 9 to 13, when the second additive was added together with the first additive, the electrical conductivity dramatically increased from below 800 S/cm to over 1100 S/cm.

The reason for the tendency for the use of only the acidic second additive to decrease the electrical conductivity with increasing amount of second additive can be understood as follows. As the amount of acidic additive (second additive), such as TC4PHO, increased, the frequency of the additive bonding to the ends of the main chains of the monomers increased. This inhibited the monomers from being linked together to extend their main chains, thereby reducing the increase in the molecular weight of the resultant conductive polymer. In addition, since the additive was acidic, this decreased the pH of the polymerization liquid to increase the polymerization rate. Therefore, the conductive polymer film was decreased in orientation, crystallinity and density, thereby decreasing the electrical conductivity. The same tendency can be seen also in Examples 9 to 13, in which the electrical conductivity had a tendency to decrease as the amount of TC4PHO added increased. Therefore, TC4PHO must be added within a suitable amount range.

As seen from the above, according to the second aspect of the invention, a conductive polymer film can be formed which has excellent electrical conductivity.

### <Production of Solid Electrolytic Capacitor>

A solid electrolytic capacitor having a structure shown in FIG. 1 was produced. An anode 1 was made of a sintered body obtained by sinter forming tantalum (Ta) powder. The anode 1 has the shape of a rectangular box of 2.3 mm×1.8 mm×1.0 mm. The anode 1 of rectangular box shape has an anode lead 7 embedded in an end surface thereof, and one end of the anode lead 7 rises from the end surface. The anode lead 7 is made of tantalum (Ta). The anode 1 in which the other end of the anode lead 7 was embedded was immersed in a phosphoric acid aqueous solution, and anodized by applying a predetermined voltage thereto. By the anodization, a dielectric layer 2 made of tantalum oxide was formed on the surface of the anode 1. The dielectric layer 2 is formed also on the surfaces of the pores in the porous body of the anode 1 as described previously.

Next, the anode 1 having the dielectric layer 2 formed thereon was immersed into a polymerization liquid. The polymerization liquid used was a butanol solution prepared by mixing 3,4-ethylenedioxythiophene serving as a monomer for a conductive polymer, iron (III) p-toluenesulfonate serving as an oxidizing agent, 3-butylpyridine serving as a first additive and TC4PHO serving as a second additive in a molar ratio of 1:8:4:0.001. The anode 1 having the dielectric layer 2 formed thereon was immersed into the above polymerization liquid, and then picked up and dried, thereby forming a conductive polymer film on the dielectric layer 2. The immersion into the polymerization liquid and drying were repeated to increase and control the thickness of the conductive polymer film, thereby forming a conductive polymer layer 3 with a thickness of 50 μm.

Then, a carbon layer 4 and a silver paste layer 5 were sequentially formed on the conductive polymer layer 3 lying over the outer periphery of the anode 1, thereby providing a cathode layer 6 constituted by the carbon layer 4 and the silver paste layer 5. An anode terminal was welded to the anode lead 7 of a solid electrolytic capacitor 8 thus produced, and a cathode terminal was connected to the cathode layer 6 by a conductive adhesive. Then, the outside surface of the solid electrolytic capacitor 8 was covered with epoxy resin to seal it, thereby completing a final solid electrolytic capacitor product. The solid electrolytic capacitor thus obtained was measured in terms of ESR. The measurement of ESR was made using the LCR meter as described previously with a frequency of 100 kHz. The result of measurement made in the above manner was an ESR of 6.3 mΩ.

For comparison, a conductive polymer film was formed in the same manner as above except that only 3-butylpyridine was added as an additive to the polymerization liquid, and a solid electrolytic capacitor was produced using the conductive polymer film. The solid electrolytic capacitor for comparison was also measured in terms of ESR in the same manner as above. The measurement result was an ESR of 6.7 mΩ. As seen from the above, by forming a conductive polymer layer in a solid electrolytic capacitor according to the second aspect of the invention, the electrical conductivity of the conductive polymer layer 3 could be increased, whereby the ESR of the solid electrolytic capacitor could be reduced.

### <Production of Organic Solar Cell>

An organic solar cell having a structure shown in FIG. 2 was produced. The surface of a transparent electrode 11 made of ITO was spin coated with a polymerization liquid made of a butanol solution obtained by mixing 3,4-ethylenedioxythiophene serving as a monomer for a conductive polymer, iron (III) p-toluenesulfonate serving as an oxidizing agent, 3-butylpyridine serving as a first additive and TC4PHO serving as a second additive in a molar ratio of 1:8:4:0.001. Thereafter, the spin-coated transparent electrode 11 was allowed to stand at 50° C. for an hour, then washed in pure water and then dried, thereby forming a hole transport layer 12. Therefore, the hole transport layer 12 was formed of a thin film of poly(3,4-ethylenedioxythiophene) having a thickness of 40 nm. Next, the hole transport layer 12 was spin coated with an o-dichlorobenzene solution of poly(3-hexylthiophene), thereby forming an active layer 13 with a thickness of 50 nm. A C60 fullerene film was vacuum deposited on the active layer 13 to form an electron transport layer 14 with a thickness of 50 nm. Next, an Al film was vacuum deposited on the electron transport layer 14 using a shadow mask, thereby forming an upper electrode 15. Next, the semifinished product was sealed with a glass cap, thereby completing an organic solar cell 16. When the organic solar cell thus produced was irradiated with simulated solar light with AM1.5 (100 mW/cm²), an electromotive force of 550 mV was obtained as an open voltage. For comparison, a hole transport layer 12 was formed in the same manner as above except that only 3-butylpyridine was added as an additive to the polymerization liquid, and an organic solar cell was produced using the hole transport layer 12. When the organic solar cell for comparison was irradiated with simulated solar light in the same manner, an electromotive force of 520 mV was obtained as an open voltage. As seen from the above results, by forming the conductive polymer film according to the second aspect of the invention as a hole transport layer 12, the electrical conductivity of the hole transport layer 12 could be increased, whereby the IR drop due to interface resistance and bulk resistance could be reduced and the open voltage could be increased.

What is claimed is:

1. A conductive polymer film obtained by using a polymerization liquid containing a monomer for a conductive polymer, an oxidizing agent, and an additive having a phosphonic acid group and an organic group to polymerize the monomer for the conductive polymer on a substrate.

2. The conductive polymer film according to claim 1, wherein the additive is represented by the following general formula: 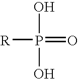
wherein R represents a hydrocarbon group having a carbon atom number of 1 to 20 or an alkyl group having a carbon atom number of 1 to 20.

3. The conductive polymer film according to claim 1, wherein the polymerization liquid contains a nitrogen-containing aromatic heterocyclic compound as an electrical conductivity improver.

4. A conductive polymer film obtained by using a polymerization liquid containing a monomer for a conductive polymer, an oxidizing agent, a basic first additive, and an acidic second additive to polymerize the monomer.

5. The conductive polymer film according to claim 4, wherein the first additive is at least one compound selected from the group consisting of nitrogen-containing aromatic heterocyclic compounds, compounds having an amido group and compounds having an imido group.

6. The conductive polymer film according to claim 4, wherein the second additive is a compound having a phosphonic acid group.

7. A conductive polymeric material in which a phosphonic acid group is attached to an end of the main chain of a polymer obtained by polymerizing a plurality of units of a conducting monomer.

8. An electronic device using the conductive polymer film according to claim 1.

9. The electronic device according to claim 8 being a solid electrolytic capacitor.

10. An electronic device comprising a conductive layer using the conductive polymer film according to claim 4.

11. The electronic device according to claim 10 being a solid electrolytic capacitor.

12. An electronic device comprising a conductive layer made of the conductive polymeric material according to claim 7.

13. The electronic device according to claim 12 being a solid electrolytic capacitor.
